(19) United States
(12) Patent Application Publication
(10) Pub. No.: US 2004/0244524 A1
(43) Pub. Date: Dec. 9, 2004

(54) Electronically actuated shifter mechanism

(76) Inventor: Ronald A. Russell, Whitehall, MI (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 10/413,764

(22) Filed: Apr. 15, 2003

(51) Int. Cl. G05G 5/00

(52) U.S. Cl. 74/473.23

(57) ABSTRACT

A shifter mechanism including a shifter lever movable along a shift path and a detent assembly. The detent assembly includes a plurality of grooves defining a plurality of gear positions along the shift path and a pawl movable along a linear path between a locking position which locks the shifter lever in one of the gear positions and an unlocking position wherein the shifter lever is movable. First and second pivotable links connect the pawl to a fixed post. An actuator operatively engages the links to selectively move the pawl along the linear path. The actuator is preferably a linear actuator having a pin movable along a linear path which is nonparallel with the pawl linear path. The first and second links preferably pivot relative to one another and relative to the pawl and the post to translate linear motion of the actuator to linear motion of the pawl.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a shifter lever mechanism for controlling transmissions of motor vehicles and, more particularly, to an electrically operated detent assembly for holding the shifter lever in a desired gear position against movement to other gear positions.

### BACKGROUND OF THE INVENTION

In a vehicle equipped with an automatic transmission, a shifter lever mechanism is typically pivotable over a series of positions representative of desired transmission gears such as, for example, park (P), reverse (R), neutral (N), drive (D), and low gears (D1, D2). The shifter lever mechanism is connected to the motor vehicle transmission by a suitable mechanical and/or electronic operating linkage to effect actuation of the transmission to the selected gear when the shifter lever is pivoted to the transmission gear's representative position. The shifter lever mechanism is typically provided with a detent assembly which releasably holds the shifter lever mechanism in position. The detent assembly typically includes a mechanical actuator which is manually operated to release the detent assembly and permit manual pivoting of the shifter lever mechanism to a new position.

The shifter lever mechanism also typically includes a lock assembly which prevents movement of the shifter lever mechanism from the park position unless a brake pedal is depressed or other desired precautions are met to reduce the likelihood of unattended or unintended acceleration or the like. These lock assemblies are typically mechanically or electrically actuated devices which block movement of the detent assembly unless the predetermined conditions are met.

U.S. Pat. No. 5,220,984, the disclosure of which is expressly incorporated herein in its entirety by reference, discloses a shift mechanism. This shifter mechanism attempts to simplify construction by providing an electrically actuated detent assembly with an electrical circuit which prevent actuation unless predetermined conditions are met such as the brake pedal being depressed. While this shifter mechanism is effective in eliminating the need for a separate lock assembly, the detent assembly may be costly to manufacture and assemble primarily due to the high tolerance parts required. Additionally, this shifter mechanism may not lend itself to shifter mechanisms having a relatively small package size. Accordingly, there is a need in the art for an improved shifter mechanism.

### SUMMARY OF THE INVENTION

The present invention provides a shifter lever mechanism which overcomes at least some of the above-noted problems of the related art. According to the present invention, a shifter lever mechanism comprises, in combination, a shifter lever movable along a shift path and a detent assembly. The detent assembly includes a plurality of grooves defining a plurality of gear positions along the shift path, a pawl movable along a linear path between a locking position wherein the pawl engages one of the plurality grooves to lock the shifter lever in one of the plurality of gear positions and an unlocking position wherein the shifter lever is movable along the shift path between the plurality of gear positions, and a linear actuator operatively coupled to the pawl to selectively move the pawl along the linear path of the pawl. The linear actuator includes a pin extendable along a linear path which is nonparallel with the linear path of the pawl.

According to another aspect of the present invention, a shifter lever mechanism comprises, in combination, a shifter lever movable along a shift path and a detent assembly. The detent assembly includes a plurality of grooves defining a plurality of gear positions along the shift path, a pawl movable along a linear path between a locking position wherein the pawl engages one of the plurality grooves to lock the shifter lever in one of the plurality of gear positions and an unlocking position wherein the shifter lever is movable along the shift path between the plurality of gear positions, a plurality of pivoting links connected to the pawl, and an actuator operatively coupled to the links to selectively move the pawl along the linear path of the pawl.

According to yet another aspect of the present invention, a shifter lever mechanism comprises, in combination, a shifter lever movable along a shift path and a detent assembly. The detent assembly includes a plurality of grooves defining a plurality of gear positions along the shift path, a pawl movable along a linear path between a locking position wherein the pawl engages one of the plurality grooves to lock the shifter lever in one of the plurality of gear positions and an unlocking position wherein the shifter lever is movable along the shift path between the plurality of gear positions, first and second pivotable links which connect the pawl to a fixed post, and an actuator operatively engaging the links to selectively move the pawl along the linear path of the pawl. The actuator is a linear actuator having a pin movable along a linear path which is nonparallel with the linear path of the pawl. The first and second links pivot relative to one another and relative to the pawl and the post to translate linear motion of the actuator to linear motion of the pawl.

From the foregoing disclosure and the following more detailed description of various preferred embodiments it will be apparent to those skilled in the art that the present invention provides a significant advance in the technology and art of motor vehicle shifter lever mechanisms. Particularly significant in this regard is the potential the invention affords for providing a high quality, reliable, low cost assembly which utilizes a relatively small amount of center console space. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a shifter mechanism according to the present invention generally showing the right and rear sides of the shifter mechanism;

FIG. 2 is an enlarged, fragmented perspective view showing a portion of FIG. 1 near a bottom of a lever;

FIG. 3 is a perspective view of the shifter mechanism of FIG. 1 generally showing the right and rear sides of the shifter mechanism;

FIG. 4 is a fragmented perspective view of a shifter lever knob or handle of the shifter mechanism of FIGS. 1 to 3;

FIG. 5 is an enlarged, fragmented perspective view showing a pawl or lock assembly of the shifter mechanism of FIGS. 1 to 3 in a locked condition;

FIG. 6 is a perspective view similar to FIG. 5 but showing the pawl assembly in an unlocked condition;

FIG. 7 is a sectional view taken along line 7-7 of FIG. 5 wherein some features are removed for clarity; and

FIG. 8 is a schematic view of the pawl assembly of the shifter mechanism of FIGS. 1 to 6.

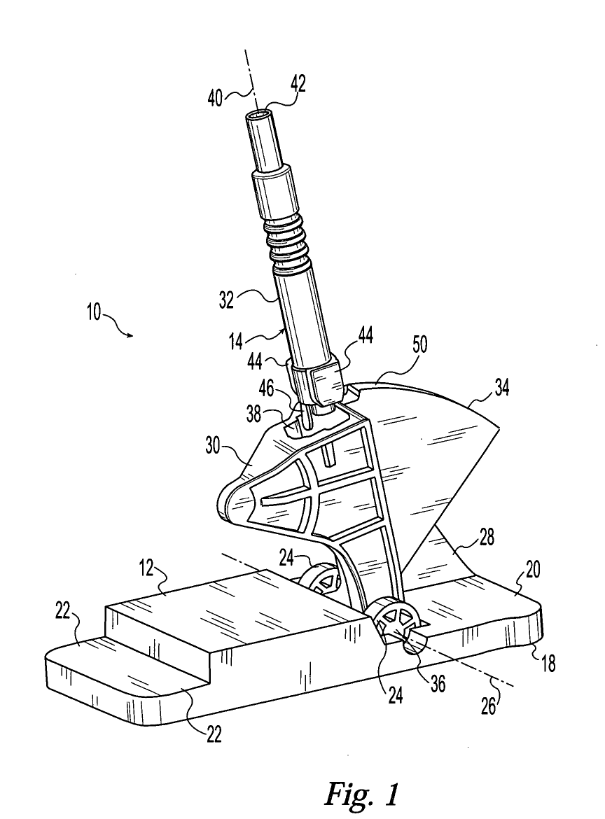

It should be understood that the appended drawings are not necessarily to scale, presenting a somewhat simplified representation of various preferred features illustrative of the basic principles of the invention. The specific design features of a shifter lever mechanism as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the shifter lever mechanism illustrated in the drawings. In general, up or upward generally refers to an upward direction in FIG. 1 and down or downward generally refers to a downward direction in FIG. 1. Also in general, fore or forward refers to a direction toward the front of the vehicle, that is, generally toward the right in FIG. 1 and aft or rearward refers to a direction toward the rear of the vehicle, that is, generally toward the left in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved shifter lever mechanism disclosed herein. The following detailed discussion of various alternative and preferred embodiments will illustrate the general principles of the invention with reference to a shifter lever mechanism for a motor vehicle such as an automobile, sport utility vehicle (SUV), or truck. Other embodiments suitable for other applications will be apparent to those skilled in the art given the benefit of this disclosure.

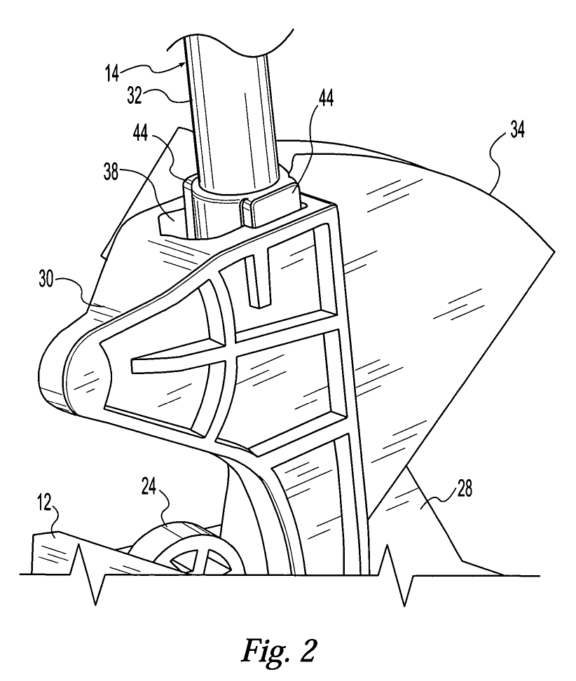

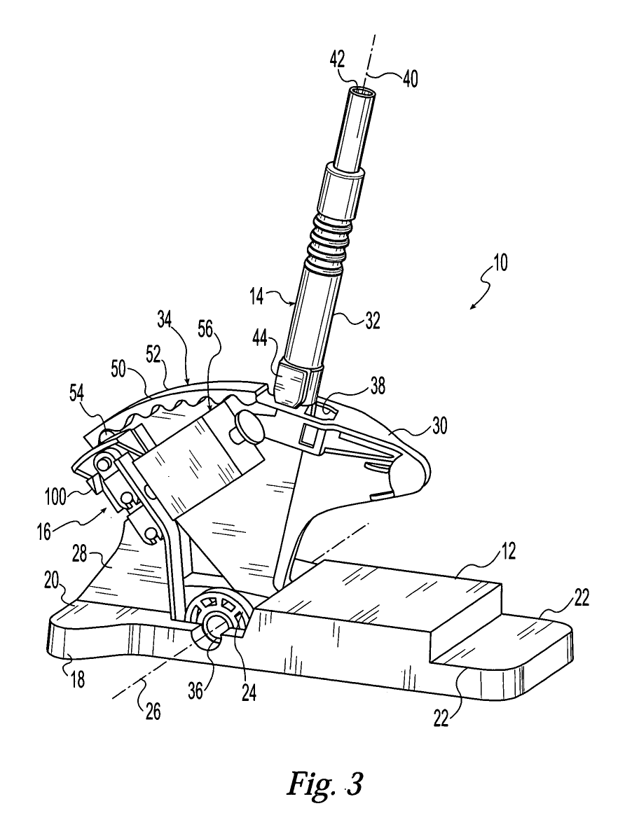

Referring now to the drawings, FIGS. 1 to 4 show a shifter lever mechanism 10 according to a preferred embodiment of the present invention. The illustrated shifter lever mechanism 10 includes a frame or base 12, a shifter lever assembly 14 pivotably mounted to the base 12, and a lock or detent assembly 16 releasably holding the shifter lever assembly 14 in a desired one of a plurality of gear positions against undesired movement to the other gear positions.

The base 12 is adapted to be attached to the motor vehicle in a fixed position such as a floor or console. The base 12 is generally planar and shaped to engage the motor vehicle in a desired manner. A pair of front flanges or ears 18 outwardly extend from the forward end of the base 12 and are provided with openings or holes 20 for receiving mechanical fasteners such as bolts to secure the base to the motor vehicle. The rearward end of the base 12 is provided with a pair of openings or holes 22 for receiving mechanical fasteners such as bolts to secure the base to the motor vehicle. Other suitable attachment means or systems will be apparent to those skilled in the art. A pair of upwardly extending pivot flanges 24 are provided along a central portion of the base 12 at lateral sides of the base 12. The pivot flanges 24 are laterally spaced apart and provided with concentric openings for pivotably mounting the shifter lever assembly therebetween as described in more detail hereinafter. The flange openings define a horizontal and laterally extending pivot axis 26 for the shifter lever assembly 14. An upwardly extending mounting flange or bracket 28 is provided at the front of the base 12. The mounting flange 28 supports the detent assembly 16 as described in more detail hereinafter.

The illustrated shifter lever assembly 14 includes a pivot member 30, a shifter post or lever 32 for manually moving the pivot member 30, and a detent plate or member 34 for interacting with the detent assembly 16 to maintain the shifter lever assembly 14 in a desired position. The lower end of the pivot member 30 is sized and shaped to extend between the pivot flanges 24 of the base 12 and is provided with horizontal, laterally extending, opposed pivot pins 36 which cooperate with the flange openings to provide a pivotable connection between the pivot member 30 and the base 12. Pivotably connected in this manner, the pivot member 30 is pivotable about the laterally extending pivot axis 26. The upper end of the pivot member 30 is provided with an opening 38 for securing the shifter lever 32 to the pivot member 30 as described in more detail hereinafter.

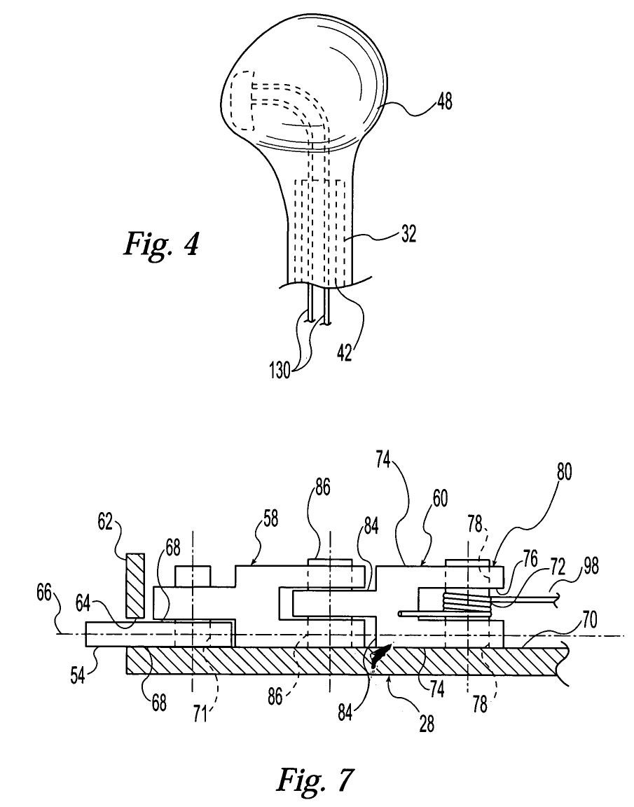

The shifter lever 32 is generally an elongate tube having a central axis 40 and forming a hollow central passage 42 extending along the central axis 40. The lower end of the shifter lever 32 is adapted to extend into the opening 38 in the pivot member 30 and is provided with opposed flanges side flanges 44 which cooperate with the opening 38 to limit rotational movement of the shifter lever 32 within the opening 38 about the central axis 40. The illustrated shifter lever 32 is provided with a resiliently deflectable arm 46 which cooperates with the pivot member 30 to form a Snap fit connection. The snap fit connection permits the shifter lever 32 to be rigidly secured to the pivot 30 without the use of mechanical fasteners by inserting the shifter lever 32 into the opening 38 so that the arm 46 deflects during entry and resiliently snaps back upon full insertion to deny withdrawal of the shifter lever 32 from the opening 38. It is noted that the snap fit connection can alternatively be provided in other suitable manners and the shifter lever 32 can alternatively be secured to the pivot member 30 in other suitable manners such as, for example, welding, adhesives, or mechanical fasteners or the lever 32 can be formed unitary, that is as one piece, with the pivot member 30. With the shifter lever 32 secured to the pivot member 30, the pivot member 30 can be pivoted about the pivot axis 26 by manually applying a force to the pivot lever 32. As best shown in FIG. 4, the upper end of the shifter lever 32 is preferably provided with handle or knob 48. The knob 48 is preferably provided with a shape to provide a suitable gripping surface for the hand of the operator.

The detent plate 34 is rigidly secured to the pivot member 30 and pivots with the pivot member 30 about the pivot axis 26. The illustrated detent plate 34 is provided with an arc-shaped flange 50 having a center of curvature at the pivot axis 26. The illustrated flange 50 laterally extends from the detent plate 34 and has a lower contoured surface with a plurality of downward facing grooves or notches 52 formed therein. The grooves 52 correspond with various gear positions in which the shifter lever assembly 14 can be shifted to provide a desired gear at the transmission of the motor vehicle. The grooves 52 can indicate positions such as park (P), reverse (R), neutral (N), drive (D), first gear (1), and second gear (2). The shifter lever assembly is suitably connected to the transmission of the motor vehicle such that movement the shifter lever 32 to the various positions causes the transmission to move to the corresponding gear. The grooves 52 pivot about the pivot axis 26 with the detent plate 34 when the shifter lever 32 is pivoted and are sized and shaped to cooperate with the detent assembly 16 to limit movement as discussed in more detail hereinbelow. The illustrated grooves 52 are arcuate and are each similarly sized and shaped. It is noted that the grooves 52 can alternatively have other suitable shapes such as, for example, a rectangular or square shape and can each be shaped differently from one another if desired.

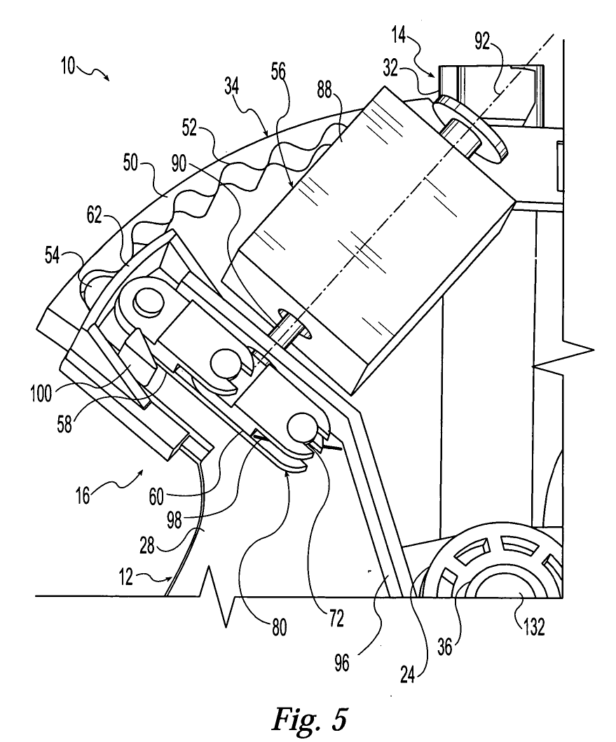

As best shown in FIGS. 5 to 7, the lock or detent assembly 16 preferably includes a pawl 54 movable into and out of engagement with the grooves 52, an actuator 56 for selectively moving the pawl 54, and a pair of links 58, 60 connecting the pawl 54 and the actuator 56 for selected movement of the pawl 54 into and out of engagement with the grooves 52. The detent assembly 16 is secured to the base at the mounting flange 28. The mounting flange 28 is provided with a guide wall 62 adjacent to and facing the grooves 52. The guide wall 62 forms a guide opening 64 for passage of the pawl 54 so that the pawl 54 can be linearly moved along a linear path 66 extending toward and away from the grooves 52, that is, in a direction substantially perpendicular to the groove 52 adjacent to the guide opening 64 as described in more detail herein below.

The illustrated pawl 54 generally planar or flat having opposed planar side surfaces 68. One of the side surfaces 68 which is located adjacent the mounting flange 28 moves or slides along a flat or planar surface 70 of the mounting flange 28 as the pawl 54 moves along its linear path 66 toward and away from the groove 52. The pawl 54 is sized and shaped to closely cooperate with the guide opening 64 so that the guide opening 64 guides the pawl to maintain movement of the pawl 54 along the linear path 66. A first or engagement end of the pawl 54 is sized and shape to cooperate with the grooves 52 of the detent plate so that the pawl 54 blocks and limits pivotal movement of the shifter lever assembly 14 when the engagement end is in, one of the grooves 54 but permits pivotal movement of the shifter lever assembly 14 when the engagement end of the pawl 54 is removed from the grooves 52. The engagement end of the illustrated pawl 54 is generally round or arcuate to cooperate with the arcuate grooves 52. A second or attachment end of the pawl 54 is sized and shaped to be attached to one of the links 58, 60. The illustrated second end has a laterally extending opening 71 sized and shaped to receive a portion of the links 58, 60 therein as described in more detail hereinafter.

The illustrated embodiments includes two of the links 58, 60 but it is noted that other quantities of links 58, 60 can be utilized within the scope of the present invention. The first link 58 is pivotally attached to the pawl 54 and the second link 60 is pivotally attached to the first link 58 and pivotally attached to a post 72 laterally extending from the mounting flange 28. The illustrated post 72 is cylindrically shaped with a free end but other suitable shapes can be utilized within the scope of the present invention. The post 72 is located so that a centerline of the post 72 is perpendicular to and intercepting the centerline of the linear path 66 of the pawl 54.

The illustrated first and second pawls 58, 60 are identical so only the second link 60 is described in detail hereafter but it is noted that the various links 58, 60 can have different sizes and/or shapes within the scope of the present invention. The link 60 is generally planar or flat having opposed planar side surfaces 74. One of the side surfaces 74 which is located adjacent the mounting flange 28 moves or slides along the flat or planar surface 70 of the mounting flange 28 as the link 60 pivots as described hereinafter. A first end of the link 60 is provided with a slot 76 and laterally extending openings 78 to form a clevis 80. The openings 78 are sized and shaped to receive the post 72 therein such that the link 60 is pivotable about the post 72 when the post 72 is received within the openings 78. The illustrated first end of the link 60 also has notches 82 which open into the openings 78 for snap-in insertion of the post 72 into the openings 78. The link 60 is preferably formed of a resilient material such that the clevis 80 resiliently deforms as the post 72 is inserted into the openings 78 through the notches 82 and resiliently snaps back to retain the post 72 within the openings and pivotably secure the link 60 to the post 72. It is noted that the link 60 can be formed in other suitable manners to pivotally secure the link to the post 72. A second end of the second link 60 has opposed notches 84 on lateral sides so that the second end is sized and shaped to be received within the slot 76 in the first end of the first link 58. The first end also has a pair of opposed, coaxial and laterally extending pegs or axles 86 which are sized and shaped to cooperate with the clevis openings 78 of the first link 58 and also the attachment opening 71 of the pawl 54. The illustrated axles 86 are sized and shaped to be similar to the post 72, that is, generally cylindrically shaped and having a combined length about equal to the length of the post 72.

The first end of the second link 60 is secured to the post 72 with the post extending into the clevis openings 78 of the second link 60 such that the second link 60 is pivotable about the post 72. The second end of the second link 60 is secured to the first end of the first link 58 with the axles 86 of the second link 60 extending into the clevis openings 78 of the first link 58 such that the first and second links 58, 60 are pivotable relative to one another. The second end of the first link 58 is secured to the second end of the pawl 54 with one of the axles 86 of the first link 58 extending into the opening 71 of the pawl 54 such that the first link 58 is pivotable about the pawl opening 71. The second end of the pawl 54.is sized and shaped to cooperate with the notch 84 of the first link 54 so that the pawl 54 is located within the notch 54 between the first link 58 and the mounting bracket 28.

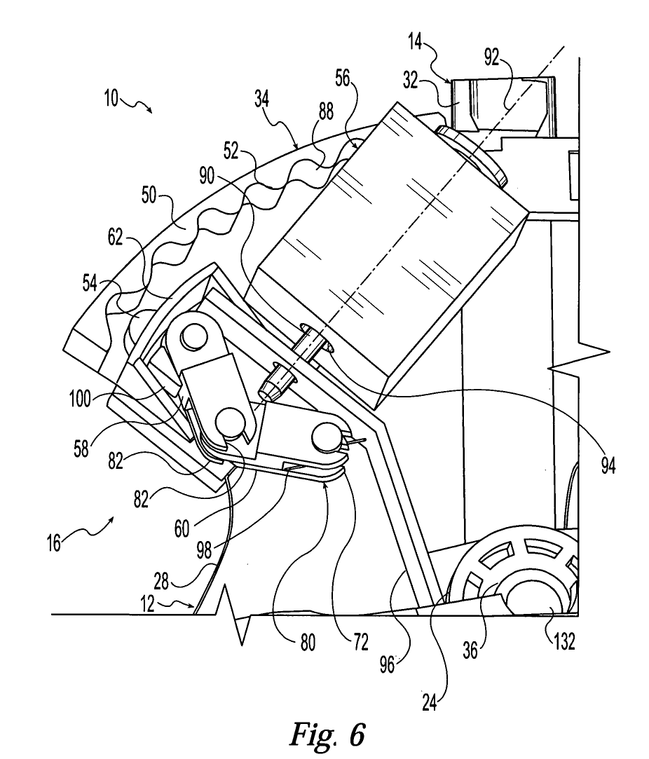

The illustrated actuator 56 is a linear actuator in the form of a solenoid but any other suitable actuator can be utilized within the scope of the present invention. The illustrated solenoid 56 includes a body or housing 88 and an extendable pin or shaft 90. The pin 90 has a central axis 92 and is typically in a retracted position (best shown in FIG. 5) but linearly moves along the central axis 92 to an extended position (best shown in FIG. 6) when the solenoid 56 is activated. The solenoid 56 is secured to the mounting flange 28 with the pin 90 extending through an opening 94 in a side wall 96 of the mounting flange 28 to engage second end of the first link 58 near the pivotable connection between the first and second links 58, 60. The solenoid 56 is preferably positioned such that the linear path 92 of the pin 90 is substantially perpendicular to the linear path 66 of the pawl 54. It is noted, however, that the linear path 92 of the pin can be at acute angles to the linear path 66 of the pawl 54 which are nonparallel. When the solenoid 56 is unactivated, the pawl 54 and links 58, 60 are aligned with the pawl 54 in the locking position. When the solenoid 56 is activated and the pin 90 linearly moves from the retracted position to the extended position, the pin 90 pushes the second link 60 such that the second link 60 pivots about the post 72. The pivoting motion of the second link 60 simultaneously pivots the first link 54 about the opening 71 of the pawl 54 and linearly moves the pawl 54 from the locking position to the unlocking position. The pawl 54 thereby linearly moves to the unlocking position, that is out of the groove, 52 by activating the solenoid 56. It should be appreciated that the articulated or pivoting motion of the links 58,60 converts the linear motion of the solenoid pin 90 into the perpendicular linear motion of the pawl 54.

When the solenoid 56 is unactivated, the pin 90 retracts from the extended position to the retracted position. A spring member 98 pivots the links 58, 60 to linearly move the pawl 54 back to the locking position. Thus the spring member 98 biases the pawl 54 into the locking position. The spring member 98 is sized such that it provides a suitable force to maintain the pawl 54 in the locking position but is resiliently overcome by the actuator 56 when it is desired to move the pawl 54 into the unlocking position. The illustrated spring member 98 is a torsion spring located at the post 72 which acts between the side wall 96 and the second link 60. It is noted that other suitable types of springs and other suitable locations of the spring member 98 can be used within the scope of the present invention.

The illustrated embodiment includes a stop 100 which limits the pivoting motion of the links 58, 60 when the stop 100 is engaged as the links 58, 60 pivot when the solenoid pin 90 is extended. The illustrated stop 100 is located near the first link 58 and is provided with a planar engagement surface which is oriented at an acute angle to the linear path 66 of the pawl 54. When the first link 54 contacts the engagement surface, pivoting motion of the first link 58 stops as well as the movement of the second link 60, and the pawl 54. Pivoting motion in the other direction is limited by engagement with the solenoid pin 90 or the side wall 96 if the pin 90 is retracted within the opening 94.

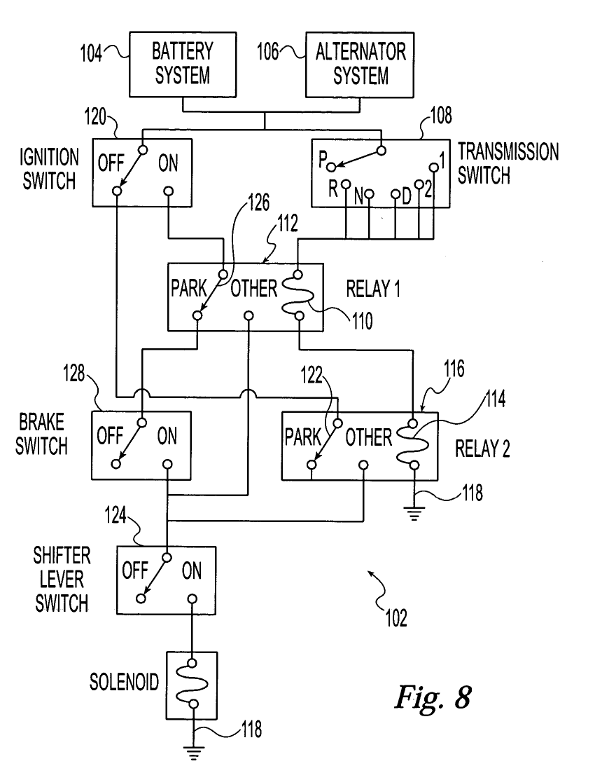

FIG. 8 schematically illustrates a preferred control circuit 102 for operation of the actuator 56. It is noted that other suitable control circuits can be utilized within then scope of the present invention. The illustrated control circuit 102 connects the coil of the solenoid 56 with power sources such as the battery system 104 and ignition/alternator system 106 of the motor vehicle. The power source 104, 106 is connected to an input of a transmission or transaxle switch 108 which indicates the position of the shifter lever assembly 14 and the present gear of the transmission. When the transmission switch 108 indicates the shifter lever assembly 14 is a position other than the park position, continuity is provided from an output of the transmission switch 108 to an input of a coil 110 of a first relay 112. The output of the first relay coil 110 is connected to the input of a coil 114 of a second relay 116. The output of the second relay coil 114 is connected to ground 118.

The power source 104, 106 is also connected to an input of an ignition switch 120 which indicates whether the ignition is on or off. When the ignition switch 120 is in the off position, continuity is provided from an output of the ignition switch 120 to an input of a switch 122 of the second relay 116 which is operated by the coil 114 of the second relay 116. When the second relay 116 is unenergized the circuit is open. When the second relay 116 is energized, the second relay switch 122 provides continuity from an output to an input of a shifter lever switch 124 which is off or on to indicate whether the operator desires to move the shifter lever assembly 14. The second relay coil 114 is energized whenever the transmission switch 108 is in a position other than park. When the shifter lever switch 124 is in the off position, the circuit is open. When the shifter lever switch 124 is in the on position, continuity is provided between an output of the shifter lever switch 124 and an input of the solenoid 56 having an output connected to ground 118. Thus when the ignition switch 120 is off, the solenoid 56 cannot be activated if the shifter lever assembly 14 is in the park position but can be activated if the shifter lever assembly 14 is in any other position. This prevents the operator from moving the shifter lever assembly 14 from the park position when the ignition switch 120 is off but allows the operator to return the shifter lever assembly 14 to the park position if the ignition switch 120 was accidentally turned off before the shifter lever assembly 14 was moved to the park position.

When the ignition switch 120 is in the on position, continuity is provided from an output of the ignition switch 120 to an input of a switch 126 of the first relay 112 which is operated by the coil 110 of the first relay 112. With the first relay coil 110 energized, continuity is provided from an output of the first relay switch 126 to the input of the shifter lever switch 124. The first relay coil 110 is energized whenever the transmission switch 108 is in a position other than park. Thus, when the ignition switch 120 is on and the transmission is switch 108 in other than park, activation and deactivation of the solenoid 56 is controlled simply by activation and deactivation of the shifter lever switch 124 by the operator. With the first relay coil 110 unenergized, continuity is provided from an output of the first relay switch 126 to an input of a brake switch 128 which indicates if the brakes of the motor vehicle are applied by the operator. When the brake switch 128 is in the off position, the circuit is open. When the brake switch 128 is in the on position, continuity is provided between an output of the brake switch 128 and an input of the shifter lever switch 124. Thus, when the ignition switch 120 is on and the transmission switch 108 is in park position, the solenoid 56 can only be activiated and deactived by the shifter lever switch 124 if the operator is applying the brakes.

As best shown in FIG. 4, the shifter lever switch 124 is preferably provided the knob 48 located at the top of the shifter lever 32. The shifter lever switch 124 is preferably located at the lateral side of the knob 48 where the thumb of the operator is located so that the operator can activate the switch 124 by pressing the switch 124 with their thumb. The shifter lever switch 124 is preferably a momentary contact switch such as, for example, a push button switch or a dome switch. The shifter lever switch 124 is preferably located below a flexible cover so that it removes all appearance of a conventional button and removes button lash. Wires 130 connecting the switch 120 to the remainder of the circuit 102 preferably extend through a the hollow interior passage 42 of the shifter lever 32 and a hollow interior passage 132 extending through the pivot member 30 and out the pivot pins 36.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A shifter mechanism comprising, in combination:
a shifter lever movable along a shift path;
a detent assembly including a plurality of grooves defining a plurality of gear positions along the shift path, a pawl movable along a linear path between a locking position wherein the pawl engages one of the plurality grooves to lock the shifter lever in one of the plurality of gear positions and an unlocking position wherein the shifter lever is movable along the shift path between the plurality of gear positions, and a linear actuator operatively coupled to the pawl to selectively move the pawl along the linear path of the pawl; and
wherein the linear actuator includes a pin extendable along a linear path which is nonparallel with the linear path of the pawl.

2. The shifter system according to claim 1, wherein said plurality of grooves are carried with the shifter lever as the shifter lever moves along the shift path.

3. The shifter system according to claim 1, wherein said linear actuator is a solenoid.

4. The shifter system according to claim 3, wherein said pin is in an extended position when said solenoid is energized and a retracted position when said solenoid is unenergized.

5. The shifter system according to claim 1, wherein said pin is in an extended position when the pawl is in the unlocking position and a retracted position when the pawl is in the locking position.

6. The shifter system according to claim 1, further comprising a plurality of pivoting links connected to the pawl and cooperating with the linear actuator to move the pawl.

7. The shifter system according to claim 6, wherein said plurality of links connect the pawl to a fixed post.

8. The shifter system according to claim 7, wherein there are two of said links and said links pivot relative to one another and relative to the pawl and the post.

9. The shifter system according to claim 6, wherein there are two of said links and said links pivot relative to one another and relative to the pawl.

10. A shifter mechanism comprising, in combination:
a shifter lever movable along a shift path; and
a detent assembly including a plurality of grooves defining a plurality of gear positions along the shift path, a pawl movable along a linear path between a locking position wherein the pawl engages one of the plurality grooves to lock the shifter lever in one of the plurality of gear positions and an unlocking position wherein the shifter lever is movable along the shift path between the plurality of gear positions, a plurality of pivoting links connected to the pawl, and an actuator operatively coupled to the links to selectively move the pawl along the linear path of the pawl.

11. The shifter system according to claim 10, wherein said plurality of links connect the pawl to a fixed post.

12. The shifter system according to claim 11, wherein there are two of said links and said links pivot relative to one another and relative to the pawl and the post.

13. The shifter system according to claim 10, wherein there are two of said links and said links pivot relative to one another and relative to the pawl.

14. The shifter system according to claim 10, wherein the actuator is a linear actuator and includes a pin extendable along a linear path and the pin engages at least one of the links to pivot the links and move the pawl.

15. The shifter system according to claim 14, wherein the linear path of the pin is nonparallel with the linear path of the pawl.

16. The shifter system according to claim 14, wherein said linear actuator is a solenoid.

17. The shifter system according to claim 16, wherein said pin is in an extended position when said solenoid is energized and a retracted position when said solenoid is unenergized.

18. The shifter system according to claim 14, wherein said pin is in an extended position when the pawl is in the unlocking position and a retracted position when the pawl is in the locking position.

19. The shifter system according to claim 10, wherein said plurality of grooves are carried with the shifter lever as the shifter lever moves along the shift path.

20. A shifter mechanism comprising, in combination:
a shifter lever movable along a shift path;
a detent assembly including a plurality of grooves defining a plurality of gear positions along the shift path, a pawl movable along a linear path between a locking position wherein the pawl engages one of the plurality grooves to lock the shifter lever in one of the plurality of gear positions and an unlocking position wherein the shifter lever is movable along the shift path between the plurality of gear positions, first and second pivotable links which connect the pawl to a fixed post, and an actuator operatively engaging the links to selectively move the pawl along the linear path of the pawl;
wherein the actuator is a linear actuator having a pin movable along a linear path which is nonparallel with the linear path of the pawl; and
wherein the first and second links pivot relative to one another and relative to the pawl and the post to translate linear motion of the actuator to linear motion of the pawl.
